(19) United States
(12) Patent Application Publication
(10) Pub. No.: US 2018/0062313 A1
(43) Pub. Date: Mar. 1, 2018

(54) Holder to Constrain Elastic Members of a Receptacle

(71) Applicant: HEWLETT-PACKARD DEVELOPMENT COMPANY, LP., HOUSTON, TX (US)

(72) Inventors: CHIA-MIN SUN, TAIPEI CITY (TW); CHUNG-HUNG HUANG, TAIPEI CITY (TW); PEI-YU WANG, TAIPEI CITY (TW)

(21) Appl. No.: 15/557,941

(22) PCT Filed: May 21, 2015
(86) PCT No.: PCT/US15/32015

§ 371 Date: Sep. 13, 2017

(51) Int. Cl. H01R 13/639; H01R 13/627

(52) U.S. Cl. CPC H01R 13/639; H01R 12/716; H01R 13/6271

(57) ABSTRACT

Examples disclosed herein provide a system including a holder to secure a removable module. In one example, the removable module includes a plug comprising holes. The system further includes a receptacle mounted on a printed circuit board (PCB). As an example, the receptacle includes elastic members to make contact with the holes in the plug when the receptacle is to accommodate the plug of the removable module. As an example, the holder is slidable over the receptacle to constrain the elastic members of the receptacle to maintain contact with the holes in the plug of the removable module.

### BACKGROUND

Computing devices, such as laptops or thin clients, may include removable modules or modular devices located internally within the computing devices. As an example, a receptacle for accommodating a modular device may be arranged on a printed circuit board (PCB), such as a motherboard of a computing device. As an example, an internal Universal Serial Bus (USB) device could be utilized in a computing device as a boot-up device, a storage, or an expandable usage.

### BRIEF DESCRIPTION OF THE DRAWINGS

FIGS. 1a-b illustrate different views of a receptacle for accommodating a removable device or modular device, according to an example;

FIGS. 2a-b illustrate a system including a holder that is capable to secure the modular device to the receptacle while sustaining shock, vibration, and drop requirements, according to an example; and

FIGS. 3a-b illustrate the system including the holder slid to surround elastic members of the receptacle, thereby constraining movement of the elastic members, according to an example.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

When a modular device is used by a computing device on a regular basis, it may not be desirable to connect the modular device to an external port on the computing device. For example, the modular device may occupy space around the computing device and interfere with operations of the computing device. In addition, the modular device that is externally connected may be inadvertently disconnected from the computing device while in use. As a result, it may be convenient to connect such modular devices internally within the computing devices.

Examples disclosed herein provide a holder that secures a modular device internally within a computing device while sustaining shock, vibration, and drop requirements. As computing devices, such as laptops or thin clients, are prone to vibration or being dropped by users, the holder may maintain the electrical connection between the modular device and the computing device by ensuring that the physical connection between the modular device and the computing device remains intact.

As will be further described, the holder may secure modular devices of various physical dimensions, not requiring the holder to be customized for each modular device that is connected internally within the computing device. As a result, modular devices may be easily swapped out without any concern on no longer meeting shock, vibration and drop requirements.

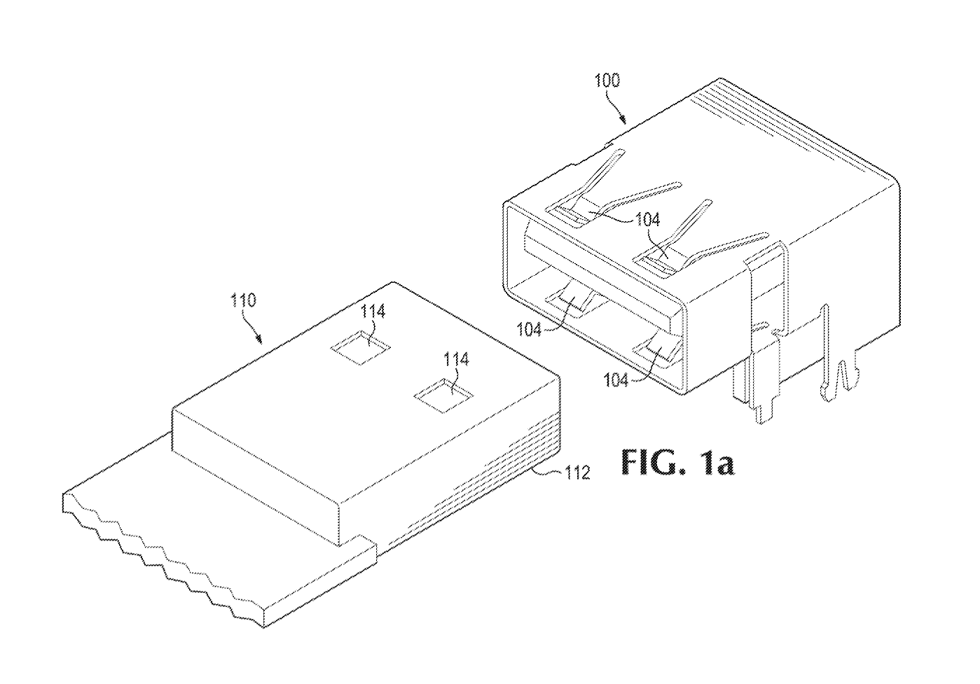

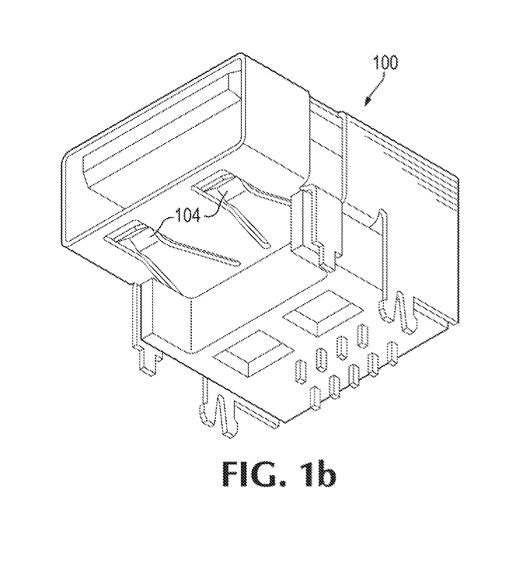

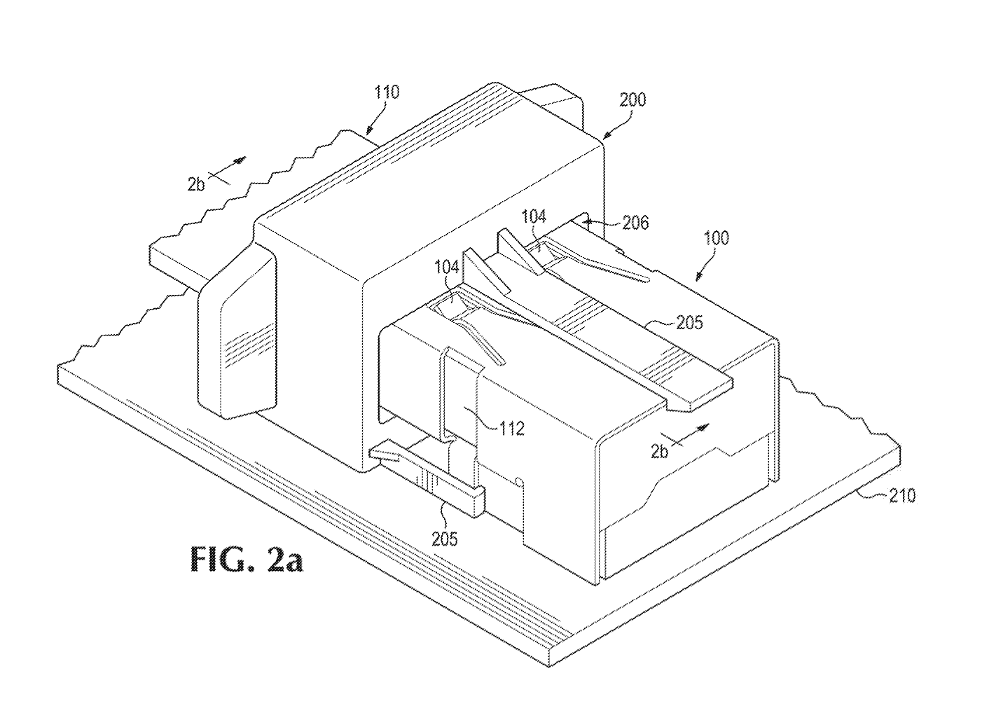

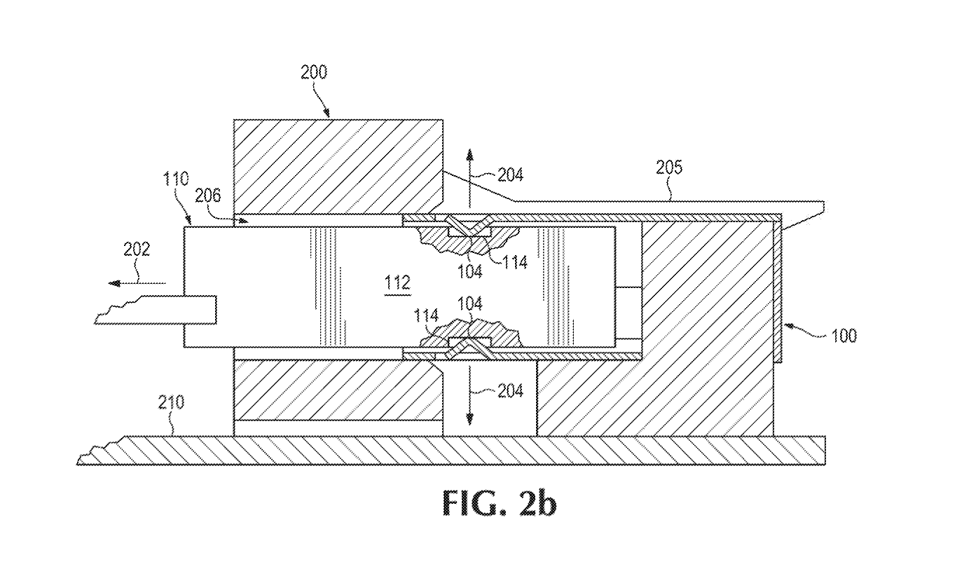

With reference to the figures, FIGS. 1a-b illustrate different views of a receptacle 100 for accommodating a removable device or modular device 110, according to an example. As mentioned above, the receptacle 100 may be mounted on and electrically coupled to a PCB within a computing device either via a socket or directly soldered to the PCB, for instance (e.g., see PCB 210 in FIG. 2a). The receptacle 100 and modular device 110 illustrated may correspond to a USB device. As mentioned above, an internal USB device could be utilized in a computing device as a boot-up device, a storage, or an expandable usage. Although the figures and the description describe features of a USB device, other platforms or connection types may be covered by the disclosure.

As illustrated, the modular device 110 includes a plug 112 for making a physical connection between the modular device 110 and the receptacle 100 in order to establish an electrical connection between the modular device 110 and the receptacle 100. As an example, the plug 112 of the modular device 110 includes a number of holes 114, and the receptacle 100 may include elastic members 104 to make contact with the holes 114 when the receptacle 100 is to accommodate the plug 112 of the modular device 110. As illustrated in FIGS. 1a-b, the receptacle 100 includes four elastic members 104 to make contact with a corresponding four holes 114 in the plug 112 of the modular device 110 (only two holes 114 illustrated). However, the number of elastic member 104 and holes 114 is not limited to what is illustrated.

When the elastic members 104 of the receptacle 100 are to make contact with the holes 114 in the plug 112 of the modular device 110, the elastic members 104 may provide a retaining force to secure the plug 112 within the receptacle 100 until an opposing force sufficient to overcome the retaining force is applied (e.g., a force that is sufficient to disconnect the modular device 110 from the receptacle 100). However, this retaining force may not be sufficient to sustain shock, vibration, and drop requirements, and may cause the modular device 110 to inadvertently drop out or disconnect from the receptacle 100.

FIGS. 2a-b illustrate a system including a holder 200 that is capable to secure the modular device 110 to the receptacle 100 while sustaining shock, vibration, and drop requirements, according to an example. As will be further described, the holder 200 may be slidable over the receptacle 100 to constrain the elastic members 104 of the receptacle 100 to maintain contact with the holes 114 in the plug 112 of the modular device 110. By constraining the elastic members 104 or movement of the elastic members 104, the retaining force provided by the elastic members 104 may be sufficient to lock the plug 112 of the modular device 110 within the receptacle 100.

Referring to FIG. 2a, the holder 200 includes a hollow opening 206 to allow for the receptacle 100 to slide through the opening 206, according to an example. The holder 200 may include a number of tabs 205, for example, to limit the movement of the holder 200 with respect to the receptacle 100. For example, referring to the tab 205 on the side of the holder 200, the tab 205 may snap into an opening along the side of the receptacle 100, as illustrated, thereby restricting the movement of the holder 200 so that the tab 205 remains within the opening. Referring to the tab 205 on the top of the holder 200, the tab 205 may include a notch that prevents the holder 200 from sliding past a certain point along the receptacle 100, as illustrated. The use and number of the tabs 205 are not limited to what is illustrated or described.

FIG. 2b illustrates a cross section of the system illustrated in FIG. 2a, according to an example. As illustrated, the holder 200 is not disposed over the receptacle 100, or particularly the elastic members 104 of the receptacle 100. As a result, once a sufficient force 202 is applied in an attempt to remove the modular device 110 from the receptacle 100, the force 202 may overcome the retaining force provided by the elastic members 104, causing the elastic members 104 to move outwards from the holes 114, indicated by arrows 204, as the modular device 110 is pulled out. As described, when the holder 200 is not disposed over the elastic members 104 of the receptacle 100, the plug 112 of the modular device 110 is removable from the receptacle 100.

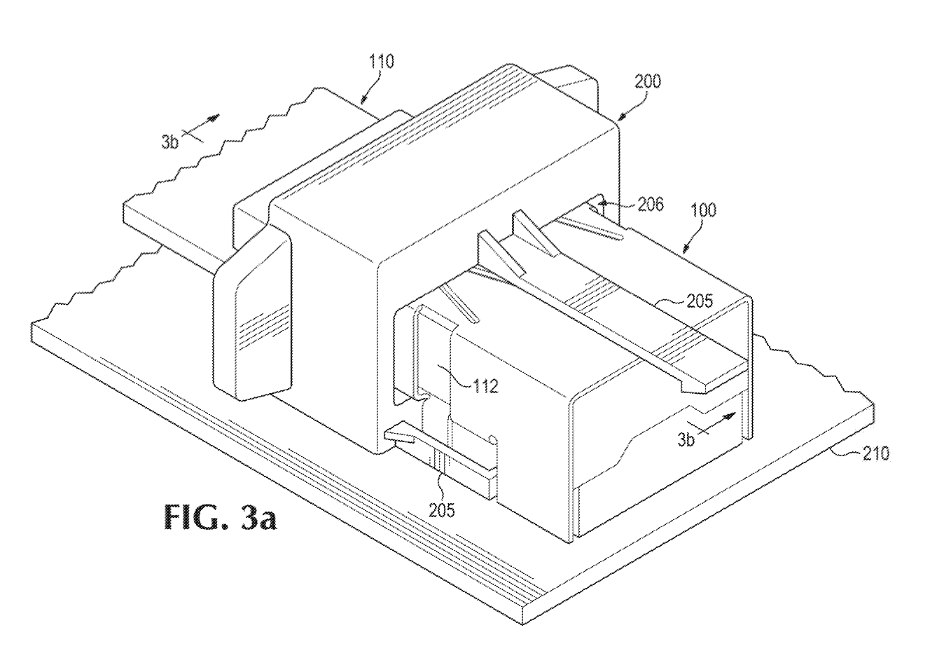

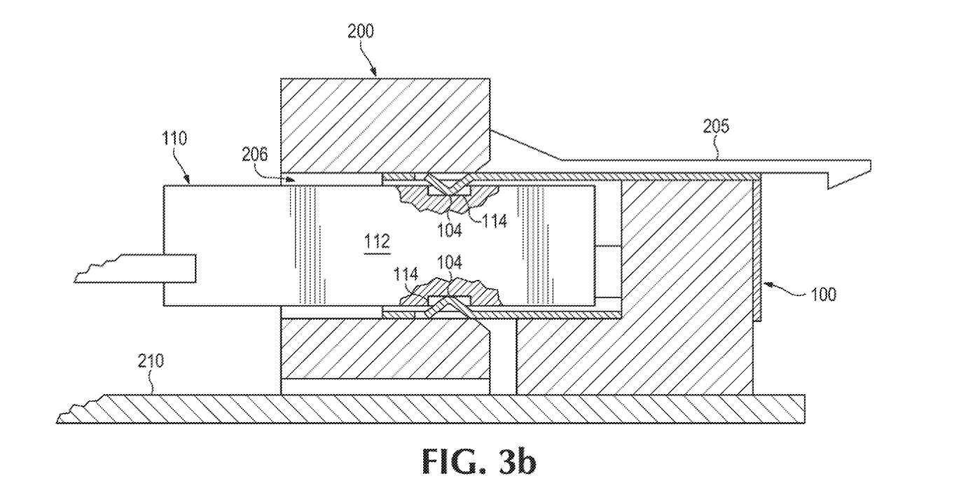

FIGS. 3a-b illustrate the system including the holder 200 slid to surround the elastic members 104 of the receptacle 100, thereby constraining movement of the elastic members 104, according to an example. By constraining the elastic members 104 or movement of the elastic members 104, the retaining force provided by the elastic members 104 may be sufficient to lock the plug 112 of the modular device 110 within the receptacle 100 and sustain any shock, vibration, and drop requirements. As described above, the tabs 205, particularly the tabs 205 on the sides of the holder 200, may restrict movement of the holder 200 until the tabs 205 reach one side of the opening along the side of the receptacle 100, according to an example.

FIG. 3b illustrates a cross section of the system illustrated in FIG. 3a, according to an example. As illustrated, the holder 200 is disposed over the elastic members 104 of the receptacle 100. As a result, although a significant amount of force may be applied in an attempt to remove the modular device 110 from the receptacle 100, as the holder 200 is disposed over the elastic members 104 any outward movement of the elastic members 104 may be restricted or prevented from occurring. Thereby, as the elastic members 104 remain within the holes 114 of the plug 112, the elastic members 104 may lock the plug 112 of the modular device 110 within the receptacle 100. As described, the holder 200 may maintain the electrical connection between the modular device 110 and the receptacle 100 of a computing device by ensuring that the physical connection between the modular device 110 and the receptacle 100 remains intact.

As described above, the holder 200 may secure modular devices of various physical dimensions, not requiring the holder 200 to be customized for each modular device that is connected internally within a computing device. For example, as the holder 200 sustains shock, vibration, and drop requirements by being slidable solely along the receptacle 100, various sizes of modular devices may be used and protected by the holder 200.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A system comprising:
a removable module comprising a plug, wherein the plug comprises holes;
a receptacle mounted on a printed circuit board (PCB), wherein the receptacle comprises elastic members to make contact with the holes in the plug when the receptacle is to accommodate the plug of the removable module; and
a holder that is slidable over the receptacle to constrain the elastic members of the receptacle to maintain contact with the holes in the plug of the removable module.

2. The system of claim 1, wherein when the elastic members of the receptacle are to make contact with the holes in the plug of the removable module, the elastic members are to provide a retaining force to secure the plug within the receptacle until an opposing force sufficient to overcome the retaining force is applied.

3. The system of claim 2, wherein when the holder is slid to be disposed over the receptacle to constrain the elastic members of the receptacle, the retaining force provided by the elastic members is to lock the plug of the removable module within the receptacle.

4. The system of claim 3, wherein the holder is slidable to surround the elastic members of the receptacle to constrain movement of the elastic members.

5. The system of claim 1, wherein when the holder is not disposed over the elastic members of the receptacle, the plug of the removable module is removable from the receptacle.

6. The system of claim 1, wherein the holder comprises tabs to limit movement of the holder with respect to the receptacle.

7. The system of claim 6, wherein the tabs snap into openings along sides of the receptacle, to restrict the movement of the holder so that the tabs remain within the openings.

8. The system of claim 1, wherein the receptacle comprises a hollow opening to allow the receptacle to slide through the hollow opening.

9. A system comprising:
a removable module comprising a plug, wherein the plug comprises holes;
a receptacle mounted on a printed circuit board (PCB), wherein the receptacle comprises elastic members to make contact with the holes in the plug when the receptacle is to accommodate the plug of the removable module; and
a holder that is slidable over the receptacle to constrain the elastic members of the receptacle to maintain contact with the holes in the plug of the removable module, wherein the holder comprises tabs to limit movement of the holder with respect to the receptacle.

10. The system of claim 9, wherein the tabs snap into openings along sides of the receptacle, to restrict the movement of the holder so that the tabs remain within the openings.

11. The system of claim 9, wherein the receptacle comprises a hollow opening to allow the receptacle to slide through the hollow opening.

12. A holder to secure a modular device to a receptacle, the holder comprising:
a hollow opening to allow the receptacle to slide through the hollow opening, wherein the receptacle comprises elastic members to make contact with holes in a plug of the modular device when the receptacle is to accommodate the plug of the modular device; and
tabs to limit movement of the holder with respect to the receptacle.

13. The holder of claim 12, wherein the holder is slidable over the receptacle to constrain the elastic members of the receptacle to maintain contact with the holes in the plug of the modular device.

14. The holder of claim 12, wherein when the holder is not disposed over the elastic members of the receptacle, the plug of the modular device is removable from the receptacle.

15. The holder of claim 12, wherein the tabs snap into openings along sides of the receptacle, to restrict the movement of the holder so that the tabs remain within the openings.
